(19) United States
(12) Patent Application Publication
(10) Pub. No.: US 2013/0073391 A1
(43) Pub. Date: Mar. 21, 2013

(54) SYSTEMS AND METHODS FOR SHARING REVENUE IN AN INTERNET PRINTING SYSTEM

(71) Applicant: CANON KABUSHIKI KAISHA, Tokyo (JP)

(72) Inventor: Chihsin Steven Young, Irvine, CA (US)

(73) Assignee: CANON KABUSHIKI KAISHA, Tokyo (JP)

(21) Appl. No.: 13/666,809

(22) Filed: Nov. 1, 2012

Related U.S. Application Data
(63) Continuation-in-part of application No. 12/142,307, filed on Jun. 19, 2008.

(51) Int. Cl. G06Q 30/02

(52) U.S. Cl. CPC G06Q 30/0247
USPC 705/14.54

(57) ABSTRACT

Systems and methods share revenue in an Internet printing system comprising a search engine provider, a host computer, and an advertisement sponsor. A user of the host computer registers with the search engine provider. The user of the host computer conducts a search utilizing the search engine provider and selects an option to print a displayed search result page. The host computer generates print data to print the search result page together with advertisement data, submits the generated print data to the printer, and receives a confirmation from the printer confirming the successful printout of the generated print data, which includes the advertisement data. The host computer notifies the search engine provider of the successful printout. The search engine provider charges the advertisement sponsor for the printing of the advertisement data and credits an account of the registered user a portion of the amount charged to the advertisement sponsor.

### CROSS-REFERENCE TO RELATED APPLICATIONS

This application is a continuation-in-part of U.S. patent application Ser. No. 12/142,307, filed on Jun. 19, 2008 and published as U.S. Publication No. 20090319371, which is hereby incorporated by reference.

### BACKGROUND

1. Field

The present disclosure concerns sharing of Internet advertising revenue. More specifically, the disclosure pertains to the sharing of revenue between an advertisement sponsor, a search engine provider, and an end user of the search engine by crediting the end user a portion of advertising revenue collected by the search engine provider from the advertisement sponsor after confirming that the end user has printed out an advertisement on a printout of a search result web page.

2. Background

Currently, a common method for advertising on the Internet is a system called pay-per-click advertising or PPC advertising. PPC advertising is an arrangement between webmasters, acting as publishers, and advertisers or advertisement sponsors, in which the webmasters display clickable links leading to the advertiser's websites, in exchange for a charge-per-click of the link. In this system, the advertisers may be susceptible to overcharging for the clicking of links. A common example in which online advertisers may be overcharged for clicked links is click fraud. Click fraud occurs when a person, automated script, or computer program imitates a legitimate user of a web browser clicking on an advertisement link, for the purpose of generating a charge-per-click without having actual interest in the target of the advertisement's link. In this case, the advertiser may be excessively charged for the false clicks.

Another example of inaccurate charging of online advertisers is when a user accidentally clicks on an advertiser's link. When a user accidentally clicks an advertiser's link, the user may quickly return to the previous website without actually viewing the advertiser's website. Yet another example of inaccurate charging of online advertisers is when a user clicks on an advertiser's link, but the web browser malfunctions and never displays the advertiser's website. In this case, the advertiser may be charged at the moment the user clicked the link with no assurance that the user actually viewed the advertiser's website or advertisement information. Accordingly, in each of these examples (click fraud, accidental clicking, and web browser error) advertisers may have to pay for advertisements that are, in reality, not viewed by the target audience.

In addition, PPC advertising does not currently provide an incentive for Internet users to click on an online advertiser's link. After a user conducts a search, there is no real motivation for the user to depart from the search results and click on an advertiser's link to view advertisements in the middle of conducting an Internet search. Of course, if the user is interested in the advertisement and clicks on the advertiser's link, the user is provided access to the advertiser's website, but the user is not provided with a monetary benefit for viewing the advertiser's website.

Moreover, in PPC advertising, advertisers generally bid on keywords that they believe their target market would type in a search bar when searching for a product or service. When a user enters a keyword query matching the advertiser's keyword bidding list, the advertiser's advertisement may or may not be shown depending on how much the advertiser bids. The list of advertiser links appears in order of the amount of the bid and is usually listed on the side of the web page or sometimes on the top of the web page, or what may be referred to as the “gutters” of the web page. Therefore, even though an advertiser is bidding on keywords and the advertiser's links are being listed with the search results of a search page, a strong possibility exists that the user will not click on the advertiser's link.

Thus, what is needed is an online advertising scheme that will provide end users with some monetary incentive to view advertisers' websites and a way for advertisers to better ensure that the end user has actually viewed their advertisements.

### SUMMARY

The present embodiments address the foregoing problems by providing systems for sharing of revenue between an advertisement sponsor, a search engine provider, and an end user of the search engine by crediting the end user a portion of advertising revenue collected by the search engine provider from the advertisement sponsor after it is confirmed that the end user has printed out an advertisement on a printout of a search result web page.

According to the embodiments, a user of a host computer capable of browsing the Internet registers with a search engine provider (e.g., Google®, Yahoo!®, or MSN®) as a participant in an Internet advertisement revenue sharing system, which may be managed by the search engine provider. The user registers with the search engine provider by, for example, signing up through the search engine provider's website, calling the search engine provider by telephone, or sending a registration form to the search engine provider through the postal service. When browsing the Internet, the user of the host computer conducts a search utilizing a web page of the search engine provider by entering search terms in the search engine web page, whereby a search result page is displayed on a browser of the host computer. The search results may include, but are not limited to, a list of relevant web sites, a list of products or services, a map, or driving directions related to the input search terms. The user of the host computer may then select an option to print the displayed search result page on a printer connected to the host computer. When selecting the print option to print the displayed results page, the user is presented with the option to print the results page either without advertisements, or to print the results page with advertisements as part of the revenue sharing system.

If the user opts to print the results page with advertisements as part of the revenue sharing system, the host computer generates print data that includes the search results page together with advertisement data and submits the generated print data to the printer for printing. In one embodiment, the search engine provider downloads both the search result page and prepared advertisement data for the printout to the host computer, wherein the downloaded advertisement data for the printout is handled by a plug-in to the browser that prepares print data that includes the search result page and the downloaded advertisement data. In another embodiment, the search engine provider prepares advertisement data and embeds the advertisement data in the search results page itself. The search engine provider then creates a new HTML web page containing the search results and the embedded advertisement data and downloads the new HTML web page for the printout to the host computer.

After the print data is submitted to the printer, the host computer confirms whether or not the printing of the job was successful. If so, the host computer notifies the search engine provider that the printout of the print data, that included the advertisement data, was successful. After being notified that the printout was successful, the search engine provider charges the advertisement sponsor for the printing of the advertisement data included in the printout. The amount charged to the advertisement sponsor may vary, depending on, for example, the size of the advertisement data, the location of the advertisement data on the printout, or the detail and quality of the advertisement data. Alternatively, the amount charged to the advertisement sponsor may be a fixed rate per advertisement data. The search engine provider then credits an account of the registered end user a portion of the amount charged to the advertisement sponsor for the printing of the advertisement data. The user may then exchange the credits, for example, to get cash back, to get new printer ink cartridges, or to get other merchandise.

### BRIEF DESCRIPTION OF THE DRAWINGS

FIG. 1 depicts an example of a computing environment in which the systems and methods may be employed.

FIG. 2 depicts an example embodiment of an internal architecture of a computer workstation.

FIG. 3 depicts an example embodiment of an internal architecture of a web server.

FIG. 4 depicts an example embodiment of an internal architecture of a printer.

FIG. 5 depicts a block diagram of an example embodiment of a system for sharing Internet advertising revenue.

FIG. 6 depicts an embodiment of a process flow chart according to the example embodiments of the Internet advertising revenue sharing system.

FIG. 7 illustrates an example embodiment of a printout of a search result page with inserted advertisement data resulting from the Internet advertising revenue sharing system.

FIG. 8 illustrates an example embodiment of a system for sharing advertising revenue.

FIG. 9 illustrates an example embodiment of a system for sharing advertising revenue.

FIG. 10 illustrates an example embodiment of a method for sharing advertising revenue.

FIG. 11 illustrates an example embodiment of a method for sharing advertising revenue.

### DESCRIPTION

The following disclosure describes certain explanatory embodiments. Additionally, the explanatory embodiments may include several novel features, and a particular feature may not be essential to practice the systems and methods described herein.

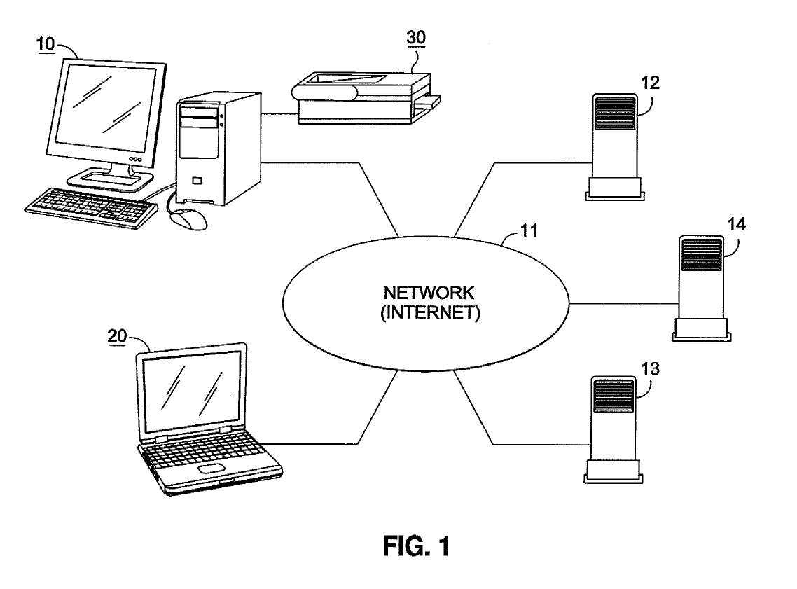

FIG. 1 depicts an example of a computing environment in which the systems and methods may be employed. Briefly, the systems and methods are directed to the sharing of revenue between an advertisement sponsor (AS), a search engine provider (SEP), and an end user of the search engine. Thus, as seen in FIG. 1, the systems and methods may be employed in an environment that includes personal computer workstation 10 or laptop computer 20 that are connected to a network 11, which may be a worldwide network such as the Internet. In this manner, computer workstation 10 or laptop 20 can communicate with any of various servers connected to the Internet so as to access various websites. For example, computer workstation 10 can communicate with server 14 for an Internet Service Provider (ISP), or server 12 for a search engine provider (SEP) as seen in FIG. 1. Of course, servers 12 and 14 are not necessarily the only servers that may be connected to the Internet and numerous additional servers may also be included. For instance, server 13 for an advertisement sponsor (AS) may also be included on the network, and other servers that host websites and various content (e.g., a web page, which may include text, graphics, or photos) that can be accessed via the Internet may also be included. Rather, servers 12 and 14 are merely representative examples and are depicted in FIG. 1 for illustrative purposes. However, ISP server 14 may be owned and operated by an Internet Service Provider so as to provide computer workstation 10 with access to the Internet. SEP server 12 may be a server owned and operated by an Internet Search Engine Provider, such as Google®, Yahoo!®, or MSN®. The end user can access SEP server 12 to conduct an internet search, whereby SEP server 12 provides computer workstation 10 with a search results page.

Computer 10 may also be connected locally to printer 30, either via a local connection or via a local area network connection (not shown). Printer 30 may be any type of printing device that prints images. For example, printer 30 may be a laser or bubble jet printer, and may also be a multi-function device, which is capable of operating as a printer, a scanner, and a facsimile device. As will be described in more detail below, printer 30 communicates with computer 10 to receive print data for printing a search result page, together with advertisement data, and to provide information to computer 10 confirming a successful print out of the search result page and the advertisements.

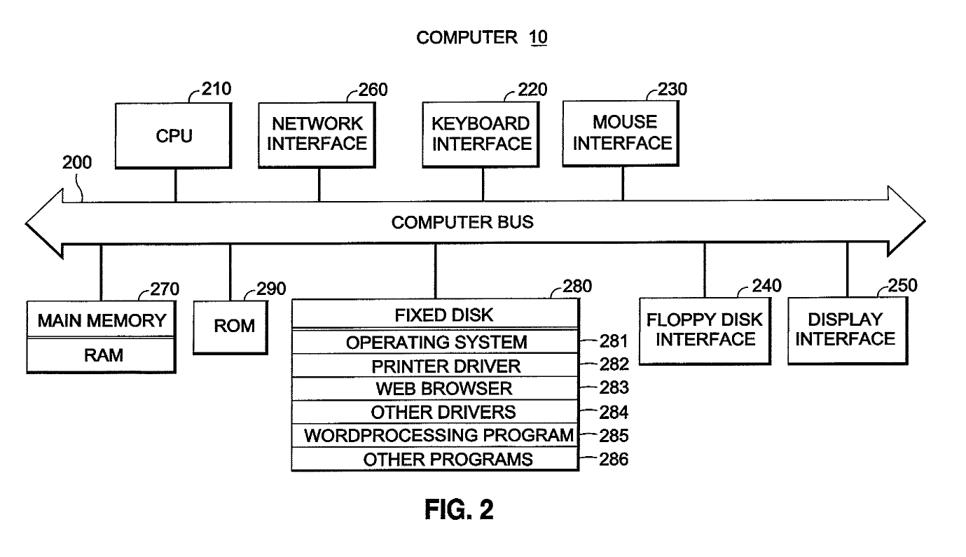

FIG. 2 is a block diagram showing an example of the internal architecture of a computer workstation, such as workstation 10. In FIG. 2, workstation 10 is seen to include central processing unit (CPU) 210, such as a programmable microprocessor which is interfaced to computer bus 200. Also coupled to computer bus 200 are keyboard interface 220 for interfacing to a keyboard, mouse interface 230 for interfacing to a mouse or other pointing device, floppy disk interface 240 for interfacing to a floppy disk, display interface 250 for interfacing to a monitor or other display, and network interface 260 for interfacing to a network, such as Internet 11. Interface 260 may be, for example, a 56K modem, a DSL modem, a cable modem, an Ethernet card that may or may not communicate with an external modem, etc.

Random access memory (RAM) 270 interfaces to computer bus 200 to provide CPU 210 with access to memory storage, thereby acting as the main run-time memory for CPU 210. In particular, when executing stored program instruction sequences, CPU 210 loads those instruction sequences from fixed disk 280 (or other memory media) into RAM 270 and executes those stored program instruction sequences out of RAM 270. It should also be noted that standard disk swapping techniques available under windowing operating systems allow segments of memory to be swapped to and from RAM 270 and fixed disk 280. Read-only memory (ROM) 290 stores invariant instruction sequences, such as start-up instruction sequences for CPU 210 or basic input/output operation system (BIOS) sequences for the operation of peripheral devices (not shown) attached to workstation 10.

Fixed disk 280 is one example of a computer-readable medium that stores program instruction sequences executable by CPU 210. The program instructions may constitute operating system 281, printer driver 282, web browser 283, other drivers 284, word processing program 285, and other programs 286. Operating system 281 may be a windows operating system, although the other types of operating systems may be used with the present embodiments. Printer driver 282 is utilized to prepare image data for printing on at least one image forming device, such as, for example, printer 30. Web browser application 283 is preferably a browser application such as Windows Internet Explorer®, Mozilla Firefox®, or Safari™, although other web browser applications may be utilized instead. However, the web browser may support plug-ins such that, in a case where the present embodiments may be employed as a plug-in for a web browser, the embodiments may be installed and utilized with the web browser application. In addition, the web browser preferably supports various types of web page source code, including but not limited to, HTML, Java Script, etc. Other drivers 284 include drivers for each of the remaining interfaces which are coupled to computer bus 200. Word processing program 285 is a typical word processor program for creating documents and images, such as Microsoft® Word, or Corel® WordPerfect documents. Other programs 286 contain other programs necessary to operate workstation 10 and to run desired applications.

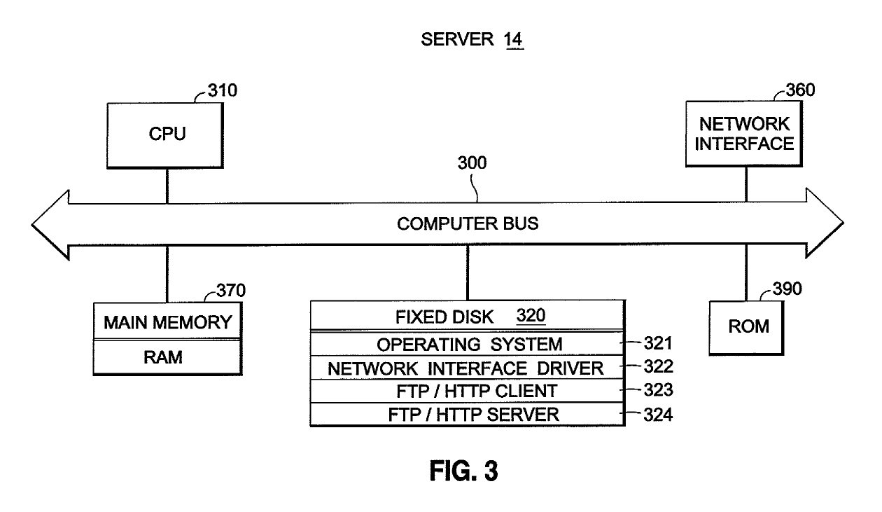

FIG. 3 depicts a block diagram showing an overview of the internal architecture of a server, such as servers 12, 13 and 14. In this regard, the internal architecture of these servers may be similar, and the description will be made for ISP server 14. In FIG. 3, ISP server 14 is seen to include a central processing unit (CPU) 310 such as a programmable microprocessor which is interfaced to computer bus 300. Also coupled to computer bus 300 is a network interface 360 for interfacing to a network, such as Internet 11. In addition, random access memory (RAM) 370, fixed disk 320, and read-only memory (ROM) 390 are also coupled to computer bus 300. RAM 370 interfaces to computer bus 300 to provide CPU 310 with access to memory storage, thereby acting as the main run-time memory for CPU 310. In particular, when executing stored program instruction sequences, CPU 310 loads those instruction sequences from fixed disk 320 (or other memory media) into RAM 370 and executes those stored program instruction sequences out of RAM 370. It should also be recognized that standard disk-swapping techniques allow segments of memory to be swapped to and from RAM 370 and fixed disk 320. ROM 390 stores invariant instruction sequences, such as start-up instruction sequences for CPU 310 or basic input/output operating system (BIOS) sequences for the operation of peripheral devices which may be attached to server 30 (not shown).

Fixed disk 320 is one example of a computer-readable medium that stores program instruction sequences executable by CPU 310. The program instruction sequences may include operating system 321 and network interface driver 322. Operating system 321 can be an operating system such as Windows XP (or later versions thereof), UNIX, or other such server operating systems. Network interface driver 322 is utilized to drive network interface 360 for interfacing ISP server 14 to network (Internet) 11.

Server 14 may also include FTP/HTTP client 323 to provide server 14 with the ability to retrieve and transmit data files via FTP and HTTP protocols over the network through network interface 360. In addition, FTP/HTTP server 324 can be accessed by an FTP/HTTP client in a workstation such as workstation 10. In this regard, FTP/HTTP server 324 is preferably a web server that can be accessed by web browser application 283 to retrieve and download web pages, which are preferably comprised of an HTML document. Of course, other types of web based documents, which include source code supported by the web browser, can be utilized and the embodiments are not limited to HTML. However, for the sake of brevity, the embodiments will be described with regard to HTML. A user wanting to access a web site to have a web page downloaded enters a URL (Uniform Resource Locator), or other type of location information where a web page may be stored, in the web browser of workstation 10, whereby the web page (in the form of an HTML document) is received by workstation 10 for display in the web browser. Having received the HTML document for the web page, the web browser interprets HTML source code in the HTML document to display the web page in the browser. The process of accessing web pages over the Internet or an Intranet is well known in the art and any process to have a web page downloaded and displayed in the web browser can be used to practice the embodiments. Having downloaded or otherwise accessed a web page, the web page is processed and displayed by the web browser for the user to view.

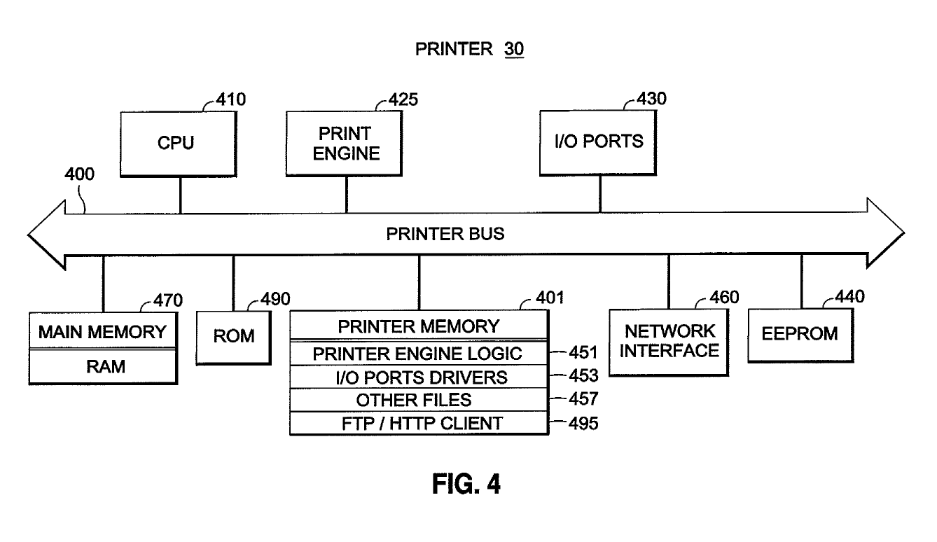

FIG. 4 depicts a block diagram showing an example of the internal architecture of a printer, such as printer 30. In FIG. 4, printer 30 contains a central processing unit (CPU) 410, such as a programmable microprocessor, which is interfaced to printer bus 400. Also coupled to printer bus 400 are I/O ports 430, which are used to communicate with various input/output devices of printer 30 (not shown), and network interface 460, which is utilized to interface printer 30 to network 11.

Also coupled to printer bus 400 are EEPROM 440, for containing non-volatile program instructions, random access memory (RAM) 470, printer memory 401, and read-only memory (ROM) 490. RAM 470 interfaces to printer bus 400 to provide CPU 410 with access to memory storage, thereby acting as the main run-time memory for CPU 410. In particular, when executing stored program instruction sequences, CPU 410 loads those instruction sequences from printer memory 401 (or other memory media) into RAM 470 and executes those stored program instruction sequences out of RAM 470. ROM 490 stores invariant instruction sequences, such as start-up instruction sequences for CPU 410 or BIOS sequences for the operation of various peripheral devices of printer 30 (not shown).

Printer memory 401 is one example of a computer-readable medium that stores program instruction sequences executable by CPU 410 so as to constitute printer engine logic 451, I/O port drivers 453, other files 457, and FTP/HTTP client 495. Printer engine logic 451 is utilized to drive the print engine 425 of printer 30 so as to print an image according to image data received by printer 30, for example over network 11. I/O port drivers 453 are utilized to drive the input and output devices (not shown) connected through I/O ports 430.

Other files 457 contain other files and/or programs for the operation of printer 30. Printer memory 401 also includes FTP/HTTP client 495, which provides the ability to retrieve files over the network through network interface 460.

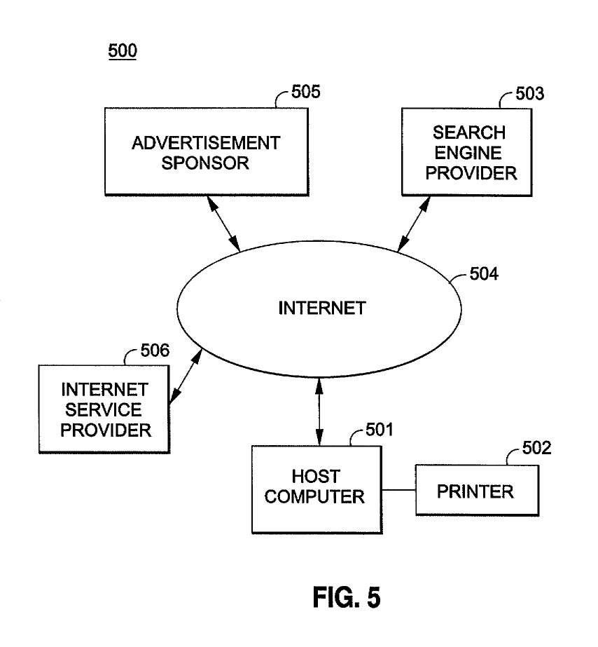

FIG. 5 depicts a block diagram of an example embodiment of a system for sharing Internet advertising revenue. As seen in FIG. 5, an Internet advertising revenue sharing system 500 includes a host computer 501 (comparable to computer 10), a printer 502 (comparable to printer 30), an Internet Service Provider 506 (comparable to server 14), a Search Engine Provider 503 (comparable to server 12), and an Advertisement Sponsor 505 (comparable to server 13), each of which communicate with one another via Internet 504. The host computer 501 may be any type of personal computer capable of connecting to and browsing the Internet 504. The host computer 501 accesses the search engine provider 503 via the Internet 504 and Internet Service Provider 506 using a web browser. The host computer 501 is also connected to the printer 502, which may be any type of printer that forms printouts on a recording medium, such as paper or the like.

The search engine provider 503 may be any type of search engine provider that provides a web search engine to search for information on the World Wide Web. The web search engine provider provides search results in the form of a web page referred to as a search engine result page (SERP).

In some embodiments, the search engine provider 503 normally enters into a contractual agreement with the advertisement sponsor 505 to have advertisements from the sponsor displayed in conjunction with the search engine web page/results page. That is, the search engine provider agrees to include advertisements themselves or links to various advertisement websites hosted by the advertisement sponsor in exchange for monetary compensation paid by the advertisement sponsor to the search engine provider. As discussed above, this type of arrangement is typically for the display of advertisements that are clicked-on by the end user, whereby the advertisement sponsor would pay the search engine provider for each click of the link. In the embodiments of the system 500, however, as will be described in more detail below, the arrangement is made based not on a link for the advertisement being clicked-on, but based on the advertisement being printed out with a search results page.

As another feature in implementing the embodiments, an end user of the web search engine enters into an agreement with the search engine provider to become a member of the advertising revenue sharing system. That is, the end user registers with the search engine provider through a registration process as described in more detail below. As will be described in more detail below, the actual sharing of the Internet advertising revenue occurs by the search engine provider crediting a portion of the money paid by the advertisement sponsor for the advertisement to the end user's account. As will be described in more detail below, the credit occurs after confirmation that the advertisement was printed out in conjunction with printing of a search results page by the end user.

Thus, as seen in FIG. 5, a host computer 501 of the end user communicates with printer 502, which may be connected locally to the host computer. Host computer 501 also communicates with Internet Service Provider 506 via Internet 504 to access the Internet when the end user invokes a browser in the host computer. After gaining access to the Internet via the ISP, when the end user enters a URL for the search engine provider in the browser, the host computer accesses the SEP 503 via Internet 504 and a webpage for the SEP is displayed in the browser. Advertisement Sponsor 505 can also communicate with SEP 503 to establish the revenue sharing contractual agreement, and to provide advertising content to SEP 503 that can be included in the search results page for printing. In addition, Advertisement Sponsor 505 can communicate directly with host computer 501 to provide advertisement content to the host computer. As will be described in more detail below, in some embodiments, a plug-in in the web browser requests content from the Advertisement Sponsor to be embedded in a printout of the search results page when the end user opts to have the search results page printed out.

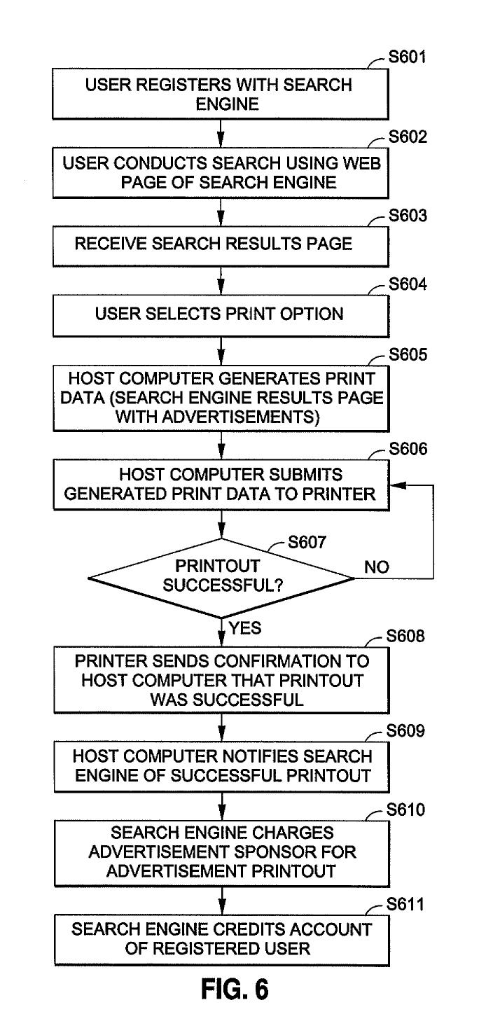

FIG. 6 is a process flow chart depicting process blocks that implement one example of the Internet advertising revenue sharing system. The process shown in FIG. 6 utilizes the configuration shown in FIG. 5, including host computer 501, printer 502, search engine provider 504, advertisement sponsor 505, and Internet service provider 506. FIG. 6 does not depict a process for the advertisement sponsor to enter into a revenue sharing agreement with the search engine provider. In this regard, any commonly known process for advertisement sponsors to enter into agreements with search engine providers for the advertisement sponsor to pay the search engine provider for displaying advertisements can be utilized. As will be described with regard to FIG. 6, however, the embodiments provide for the search engine provider to provide a portion of the revenue paid by the advertisement sponsor to end users who want to participate in the revenue sharing system. Thus, FIG. 6 is directed primarily to the process involved for an end user to take part in the system.

More specifically, in block S601 of FIG. 6, a user of the host computer 501 registers with the search engine provider 503 as a participant in the Internet advertising revenue sharing system managed by the search engine provider 503. The user may register with the search engine provider 503 by, for example, signing up through the search engine provider's web site, calling the search engine provider by telephone, or sending a registration form to the search engine provider through the postal service. Of course, other methods of registering for a product or service can be used, and the embodiments are not limited to the foregoing. Additionally, it is not mandatory that users of the search engine register with the search engine provider in order to utilize the search function of the search engine provider, but users are merely provided with the option to register if they desire.

When the user registers with the search engine provider to participate in the advertisement revenue sharing system, the user may, for example, be presented with a webpage (preferably a secure webpage) to enter personal information to set up an account. For example, the user may be requested to input items such as his name, address, telephone number, or e-mail address. The user may also be requested/required to input some type of financial institution information, such as a bank account or credit card number. In this manner, if the revenue sharing system so provides, the user may be provided with cash that is deposited into a bank account of the user. Alternatively, the search engine provider may credit an account of the user a predetermined number of points for each advertisement printing transaction. The end user may then redeem his points for coupons or discounts on purchases that can be made through the search engine provider or otherwise, including discounts on the purchase of printing supplies, such as ink and paper. Of course, other types of credits can be provided to the end user and the embodiments are not limited to any particular type of credit or cash disbursement.

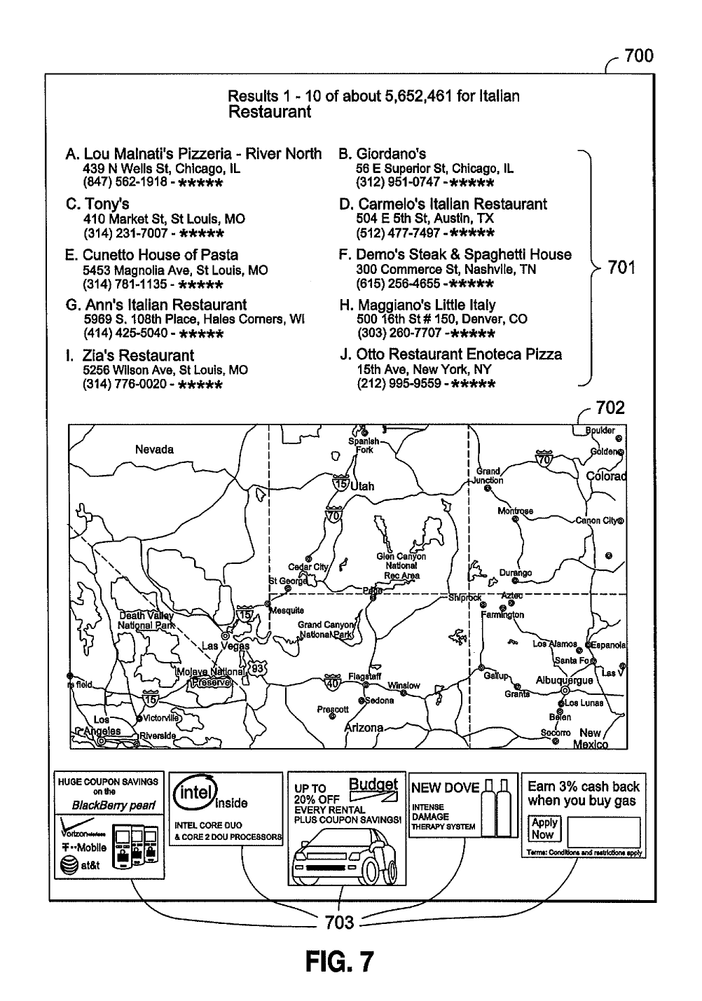

In block S602, after the user has registered with the search engine provider to participate in the advertisement revenue sharing system, the user of the host computer 501 conducts a search which utilizes a web page of the search engine provider 503. That is, the user activates a web browser on computer 501 and enters a URL of the search engine provider. An HTML webpage of the search engine provider is downloaded to and displayed by the browser. The user may then conduct a search for information such as web-sites, images, videos, businesses, products, services, etc., by entering keywords or search terms into a search dialog box on the displayed webpage of the search engine provider. When the user submits a request to have the search conducted, the search engine provider conducts a search for information relevant to the input keywords and generates a search results page. The search result page is then provided to and displayed by the browser of the host computer 501 (block S603). An example of a search results page is shown in FIG. 7.

Briefly, FIG. 7 illustrates an example embodiment of a printout of a search result page with inserted advertisement data resulting from the Internet advertising revenue sharing system. As shown in FIG. 7, print data 700 is a printout printed from printer 502 and includes search results 701 and 702 and advertisement data 703. Print data 700 is the result of printing out a search results page as a user of the Internet advertising revenue sharing system. The search results 701 and 702, as shown in FIG. 7, are a list of businesses, addresses and phone numbers for each of the found businesses; and a corresponding map, respectively. However, the search results 701 and 702 may also include, but are not limited to, driving directions, relevant web sites, a list of image thumbnails, or a list of products or services for sale.

The advertisement data 703, as shown in FIG. 7, is provided by the advertisement sponsor 505 to the search engine provider 503 and consists of advertisements for different products. However, the advertisement data 703 may also include, but is not limited to, advertisements for services, coupons, announcements, or show times for local television programming or movie theaters. Moreover, FIG. 7 shows advertisement data 703 positioned at the bottom of print data 700. However, the advertisement data 703 may also be positioned at the top, side margins, or on the back of print data 700. Additionally, the advertisement data 703 may vary in size, shape, and the amount of detail displayed in the graphics, and can either contain color or black and white graphics.

It should be noted that the search results page may be prepared by the search engine provider with advertisement content embedded in the page. That is, when the user submits the search request, based on the input keywords/search terms, and the search results obtained as a result of the search conducted by the search engine provider, the search engine provider may also search a database of advertising content to obtain advertisements that are related to the subject matter of the search. For example, if the end user conducts a search for car wash businesses in a particular locale, the search engine provider may search a database for advertisements relevant to car washing in general (e.g., advertisements for car washing material such as soap, wax, pressure washers, etc.), or advertisements relevant to car wash businesses that may be included in the search results. The search engine provider may also refer to personal information of the end user's account to determine topics of interest to the user in order to determine which advertisements the user may be more willing to want to receive, including advertisements that may be relevant to a topic other than the subject matter of the search. Once the search engine provider has obtained the relevant advertising content, it may embed the advertisements in the search results page that is provided to the web browser for display. Thus, referring again to FIG. 7, various advertisements 703 can be seen displayed in the search results page displayed by the browser.

Referring again to FIG. 6, in block S604, once the search results page is displayed by the browser, the user of the host computer 501 may select an option in the browser to print the displayed search result page on the printer 502 which is connected to the host computer 501. In a case where the user has registered with the search engine provider to participate in the revenue sharing system, and the search results page has been embedded with the advertisements by the search engine provider when the page is downloaded, the process proceeds to generate print data for submission to the printer based on the displayed search results page that already includes the embedded advertisements (block S605). Here, it is noted that in some embodiments the search results page is not embedded with the advertisement content by the search engine provider when the search results page is downloaded to the browser, but rather, the search results page is downloaded without advertisements. Thus, to accomplish the embodiments, the search results page would need to have advertisements embedded after the downloading to the browser. This alternative embodiment will be described in more detail below. As another alternative, when selecting the print option, the user may have the option of printing the search results page without advertisements and therefore without participating in the Internet advertising revenue sharing system for the current print request. That is, the print driver, when the print option is invoked, may provide an option for the user to deselect printing of advertisements that have been embedded in the search results page. In this case, no revenue sharing would be accomplished and a normal print operation of printing the search results page without advertisements would occur. In keeping with the embodiments, however, once the user confirms the printout with the advertisements, a print driver in the host computer 501 generates print data based on the displayed search results page and advertisements, and the generated print data is transmitted to printer 502 to print out the search result page together with advertisement data (block S606).

As mentioned above, some embodiments, the search engine provider downloads the search result page without advertisement content embedded in the search results page. Thus, to accomplish the embodiments, when the user invokes the print driver to print out the search results page, and if the user selects an option in the print driver to print out the search results page with advertisements, a plug-in software module for the browser may be invoked to request the downloading of advertising content to be embedded in the search results page for printing. The request may be submitted to the search engine provider, whereby the search engine provider searches the advertising content database as described above and then downloads the advertisements to the browser. The plug-in may, of course, request the advertising content from another source, including directly from the advertisement sponsor, and the embodiments are not limited to obtaining the advertisement content from the search engine provider. Regardless, once the advertisement data is downloaded to the browser, the plug-in handles the content so that it may be included in the printout. For instance, the search results page displayed on the browser may be refreshed or updated to include the advertisements so that a graphics driver for the printer driver can then generate print data for the search results page to include the advertisements for printout. As yet another alternative, the plug-in may request that the search engine provider download a newly-generated search results page that includes the advertisements such that the newly-generated search results page would be along the lines of that of the first embodiment in which the search results page originally downloaded by the search engine provider is embedded with the advertisements.

Returning to FIG. 6, in block S607, the printer determines whether the printout of print data with the advertisement data was successful. If the printout was successful, the printer informs the printer driver that the printout was successful (block S608). In some embodiments, the printer sends the printer driver a notification that confirms that ink was actually applied to paper, for example as described in U.S. patent application Ser. No. 12/398,079, filed on Mar. 4, 2009 and published as U.S. Publication No. 20100225936, which is incorporated by reference. The may prevent an erroneous successful notification, for example when the print data is sent to the spooler but not the printer, when the printer has an error and cannot print the data, etc. The plug-in for the browser then informs the search engine provider that the printout of the generated print data, which includes the advertisement data, was successful (block S609). If the printout was not successful, then more than likely an error occurred in the processing of the print data and the user is informed of the error. If the user attends to the error, the user may then resubmit the print data, and thus, the process returns to block S606.

The search engine provider, upon receiving the notification that the printout of the search results page with the advertisements was successful, charges the advertisement sponsor for the printing of the advertisement data in accordance with the contractual agreement entered into between the advertisement sponsor and the search engine provider (block S610). The amount charged to the advertisement sponsor may vary, depending on, for example, the size of the advertisement data, the location of the advertisement data in the printout, or the detail and quality of the advertisement data, again, depending on the agreement. In block S611, the search engine provider credits an account of the registered user a portion of the amount charged to the advertisement sponsor for the printing of the advertisement data. As discussed above, the credit may be in the form of a monetary payment to a bank account, a point credit to the end user's account, etc. The user may then exchange the account credits, for example, to get cash back, to get new printer ink cartridges, or to get other merchandise. As a result, the user has an incentive to print search result pages which contain the advertisement data provided by advertisement sponsor 505.

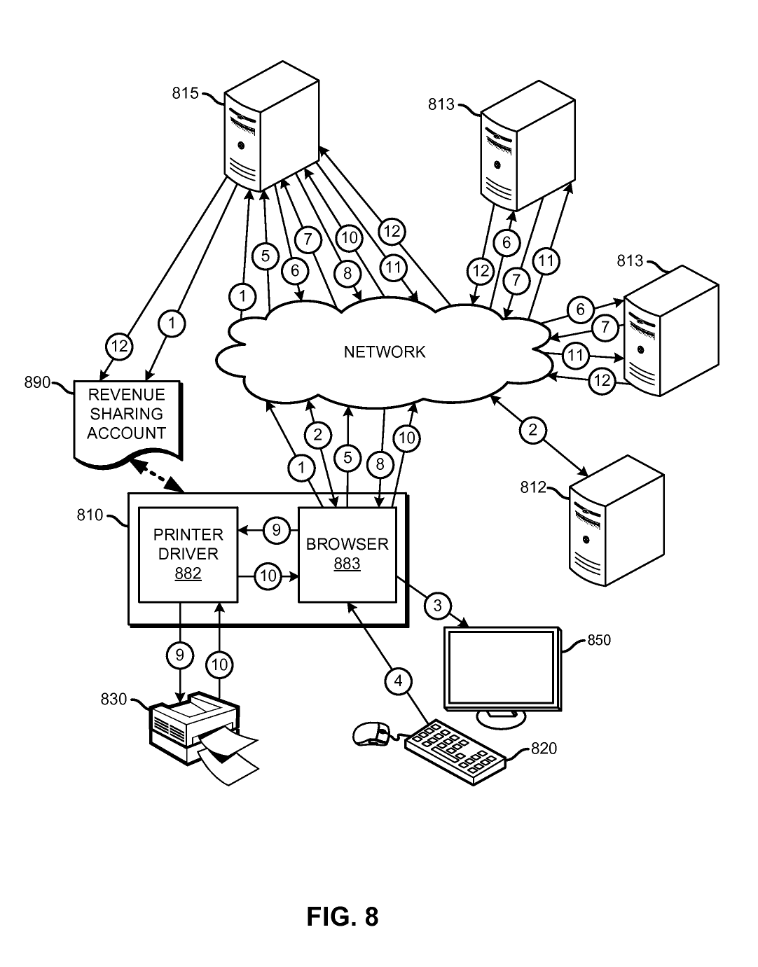

FIG. 8 illustrates an example embodiment of a system for sharing advertising revenue. The system includes a computer 810 that is associated with a user (also referred to herein as a “user computer 810”), a browser provider computer 815, a content provider computer 812, advertisement sponsor computers 813, and a printer 830. The computers communicate via one or more networks. The user computer 810 includes a printer driver 882 and a browser 883, and the user computer 810 is connected to an input device 820 and a display device 850 via respective interfaces. Also, the computers illustrated in FIG. 8 may each include multiple computers (e.g., desktops, servers, tablets, laptops, smart phones). For example, the content provider computer 812 may include multiple content servers.

Generally, in response to receiving a command to print requested content (e.g., a web page), the request being associated with a user account 890, a browser 883 (or, in some embodiments, another application) sends browser information (e.g., cookies, browsing history, favorite sites, download history, current web page, page content) to the browser provider computer 815. Based on the received browser information, the browser provider computer 815 selects one or more advertisements that were received from one or more advertisement sponsors 813 for printing. The browser provider computer 815 sends the selected advertisements to the browser 883. The advertisements and the requested content are added to print data and formatted by the browser provider computer 815 and/or the browser 883. The browser 883 sends the print data to the printer driver 882, which sends the print data to the printer 830. The printer 830 prints the print data, confirms that the print data was actually printed, and sends a confirmation to the printer driver 882. The printer driver 882 sends the confirmation to the browser 883, which sends the confirmation to the browser provider computer 815. The browser provider computer 815 sends a bill to the applicable advertisement sponsor computers 813, which send payment to the browser provider computer 815 (e.g., to an account associated with the browser provider entity). The browser provider computer 815 sends a payment (e.g., credits, money) to a revenue sharing account 890 associated with the print request. The operations are further described below.

The flow of operations starts in stage 1, in which the browser 883 obtains user account information from the user and sends the account information to the browser provider computer 815 to generate or access a revenue sharing account 890 for the user. Next, in stage 2, the browser 883 and the content provider computer 812 exchange content, for example as the browser 883 requests content for a web page (e.g., by following a link) and as the content provider computer 812 sends content to the browser 883. The browser 883 generates a display (e.g., graphic user interface) that includes the content and, in stage 3, sends the display to the display device 850 for presentation to a user. In stage 4 the browser 883 receives a command to print content, for example via the input device 820. Next, in stage 5 the browser 883 sends a request for advertisement data to the browser provider computer 815. The request for advertisement data may include browser information. Also in stage 5, the browser 883 may determine if the printer 830 has the capability to confirm that a print data has actually been printed on paper (or another print medium); may determine if a user associated with the user computer 810 has a revenue sharing account 890 that is registered with the browser provider computer 815; and, if the user does not have a revenue sharing account 890, may obtain user account information from the user and send the account information to the browser provider computer 815 to generate or access a revenue sharing account 890 for the user.

Based on the request for advertisement data received in stage 5, in stage 6 the browser provider computer 815 sends a request for advertisements to the advertisement sponsor computers 813. The request may include at least some browser information and/or information derived from the browser information, and the advertisement sponsor computers 813 may determine which advertisements to provide based on the information included in the request. In stage 7, the advertisement sponsor computers 813 send one or more advertisements to the browser provider computer 815. Also, in some embodiments, the advertisement sponsor computers 813 send one or more advertisements directly to the browser 883. Furthermore, in some embodiments, the advertisement sponsor computers 813 send advertisements and criteria to the browser provider computer 815 before stage 7, and the browser provider computer 815 stores the advertisements and criteria and also selects advertisements to print based on the criteria associated with the advertisements. For example, an advertisement sponsor computer 813 may send advertisements and related criteria to the browser provider computer 815 over the course of hours, days, weeks, and months as part of a marketing plan.

In stage 8, the browser provider computer 815 sends the selected advertisements to the browser 883. Also, in stage 8 the browser provider computer 815 and/or the browser 883 format the advertisements and/or content and generate corresponding print data that includes the advertisements and content. Then in stage 9, the browser 883 sends the print data to the printer driver 882, which sends the print data to the printer 830. The printer 830 prints the print data and, in stage 10, sends a print confirmation to the printer driver 882, which sends the print confirmation to the browser 883, which sends the print confirmation to the browser provider computer 815. In stage 11, the browser provider computer 815 sends a bill to the advertisement sponsor computers 813. Finally, in stage 12, the advertisement sponsor computers 813 send payment to the browser provider computer 815, which sends payment to the revenue sharing account 890. Also, some embodiments of the method illustrated in FIG. 8 change the order of some of the stages, add new stages, combine stages, and remove stages. For example, some embodiments perform stage 6 and/or stage 7 before stage 1.

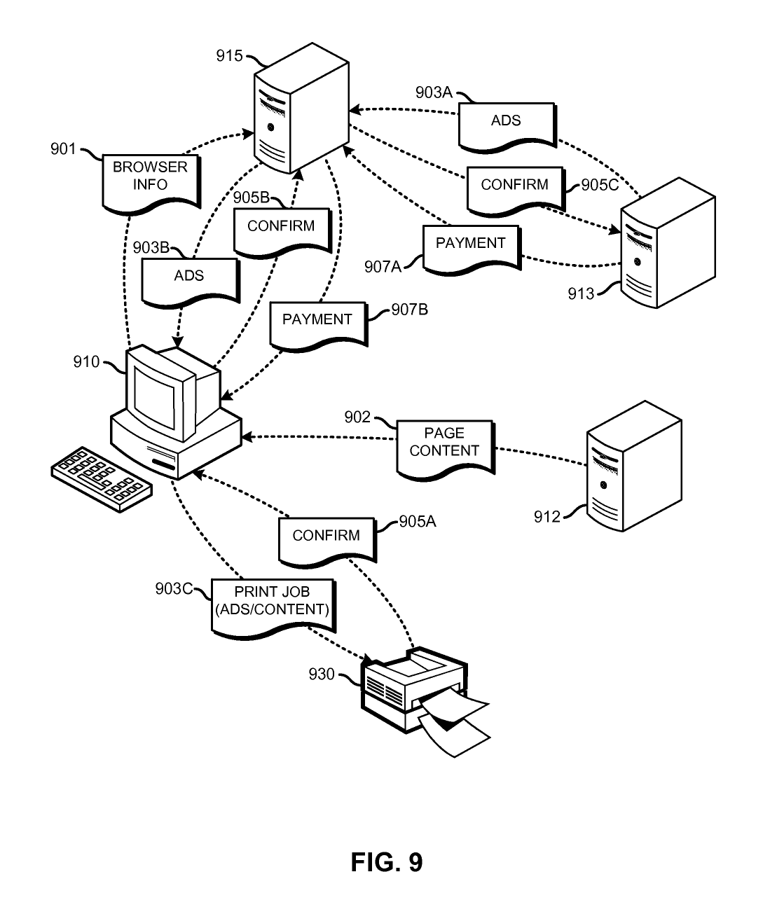

FIG. 9 illustrates an example embodiment of a system for sharing advertising revenue. The system includes a user computer 910, a browser provider computer 915, a content provider computer 912, an advertisement sponsor computer 913, and a printer 930. The computers communicate via one or more networks (not shown). The content provider computer 912 sends page content 902 to the user computer 910. The user computer 910 sends print data, which includes advertisements (“ads”) and content, to the printer 830, and the printer sends print confirmations 905A to the user computer 910.

Additionally, the user computer 910 sends browser information 901, advertisement requests, and the received print confirmations 905B to the browser provider computer 915. The browser provider computer 915 sends ads 903B to the user computer 910 and sends payment 907B to the user computer 910 or an account that has been identified by the user computer 910. Also, the browser computer 915 sends print confirmations 905C (e.g., individually, in a batch, in a summary) to the advertisement sponsor computer 913. The advertisement sponsor computer 913 sends ads 903A to the browser provider computer 915 and sends payment to the browser provider computer 915 or an account associated with the browser provider computer 915.

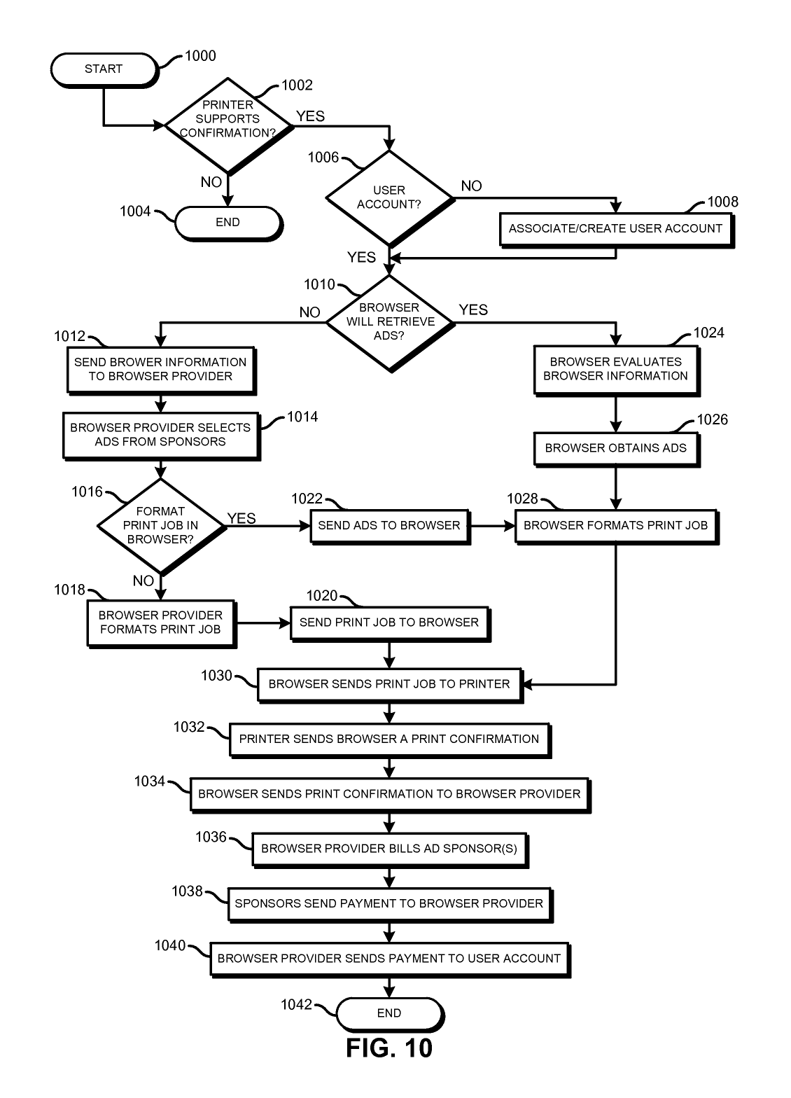

FIG. 10 illustrates an example embodiment of a method for sharing advertising revenue. The flow starts in block 1000, where a request to print content is received by a browser. A user may be prompted to select whether or not to print unrequested advertisement data with the content, and the flow proceeds to block 1002 if the user selects to proceed. In block 1002, it is determined (e.g., by a browser operating on a user computing device) if a printer supports the confirmation of the printing, for example by confirming that ink was applied to paper. If not, the flow proceeds to block 1004 and ends. If yes, then the flow proceeds to block 1006. Some embodiments do not include block 1002, though these embodiments may receive a print confirmation (e.g., from a spooler, from a driver, from a printer) without ink actually having been applied to paper.

In block 1006, it is determined if a user account is associated with the print request. For example, a user may be logged in to an account on the browser, or the user account information may have been stored in the browser. If yes, then the flow proceeds to block 1010. If not, then the flow proceeds to block 1008, where a user account is associated with the request (e.g., by prompting a user to enter account information and receiving the information from the user) or an account is generated (e.g., by prompting the user for the necessary information and receiving the information from the user). The flow then moves to block 1010.

In block 1010, it is determined if the browser will retrieve the ads. If yes, the flow proceeds to block 1024. If not, and if the browser provider will retrieve the ads, then the flow proceeds to block 1012.

If the browser provider will retrieve the ads, then in block 1012 the browser sends the browser information to the browser provider. The browser may also send the content to be printed. Then based on the browser information and/or the content, the browser provider selects ads from the sponsors in block 1014. Next, in block 1016, it is determined if the browser will format the print data. If not, then the browser provider generates and formats the print data in block 1018 and sends the print data to the browser in block 1020. The flow then proceeds to block 1030. If in block 1016 it is determined that the browser will format the print data, then the flow proceeds to block 1022, where the ads are sent to the browser. Flow then proceeds to block 1028.

If in block 1010 it is determined that the browser will retrieve the ads, then the flow moves to block 1024, where the browser evaluates the browser information to determine the ads to include. Next, in block 1026, the browser obtains the ads from the sponsors, for example by sending a request for ads to the sponsors and receiving the requested ads in response. The flow then proceeds to block 1028.

In block 1028, the browser formats the print data. Then in block 1030, the browser sends the print data to the printer. After the printer prints the print data, the printer (or printer driver or spooler) sends the browser a print confirmation in block 1032. The flow then proceeds to block 1034, where the browser sends a print confirmation to the browser provider. In block 1036, the browser provider bills the sponsor(s) of the printed ads, and in block 1038, the sponsor(s) sends payment to the browser provider. Finally, in block 1040 the browser provider sends a payment to the user account associated with the print request, and the flow ends in block 1042.

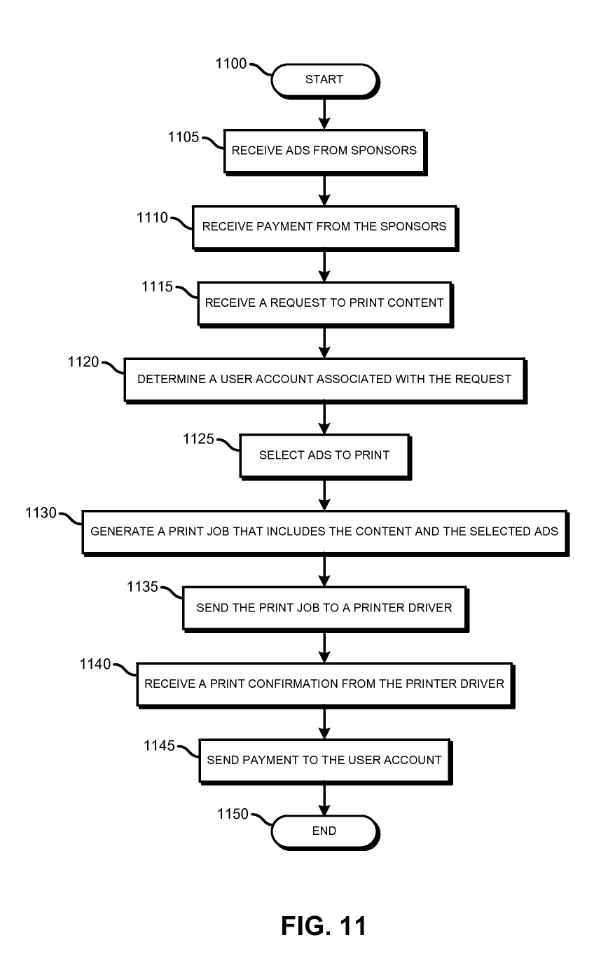

FIG. 11 illustrates an example embodiment of a method for sharing advertising revenue. The flow starts in block 1100 and proceeds to block 1105, where one or more ads are received from sponsors. The ads are stored on one or more computer-readable media. Next, in block 1110, payment is received from the sponsors, for example payment to a prepaid advertising account. The flow then moves to block 1115, where a request to print content is received (e.g., from a user input to a browser interface, received from a browser via a network). The flow then moves to block 1120, where a user account associated with the print request is determined, for example based on data stored by a browser (e.g., a credentials for a logged-in account) or by receiving account information via an interface that is presented to a user for entry of the account information.

Then in block 1125, ads are selected for printing, for example based on the browser information, the content to be printed, and/or the user account associated with the print request (e.g., if the user account is associated with a hotel, ads related to travel and hospitality may be selected, such as restaurants, museums, tourist attractions). Therefore, the ads may be selected based on the likely recipient of the print data.

Next, in block 1130, print data is generated (e.g., by the browser provider and/or the browser) that includes the content and the selected ads. In block 1135, the print data is sent to a printer driver, and in block 1140 a print confirmation is received from the printer driver. Finally, in block 1145, payment is sent to the user account, and the flow ends in block 1150.

Also, in some embodiments the printer driver performs one or more of the following: associating users with accounts or creates user accounts, retrieving advertisement data from advertisement sponsors, combining advertisement data with the user's print job, and informing a printing service (e.g., a service operated by the printer's manufacturer) of a successful print. The printing service, which may operate the user account, charges the advertisement sponsors for printing the advertisements and sends payment to the applicable user account.

The above described devices, systems, and methods can be implemented by supplying one or more computer-readable media having stored thereon computer-executable instructions for realizing the above described operations to one or more computing devices that are configured to read the computer-executable instructions and execute them. In this case, the systems and/or devices perform the operations of the above-described embodiments when executing the computer-executable instructions. Also, an operating system on the one or more systems and/or devices may implement the operations of the above described embodiments. Thus, the computer-executable instructions and/or the one or more computer-readable media storing the computer-executable instructions thereon constitute an embodiment.

Any applicable computer-readable medium (e.g., a magnetic disk (including a floppy disk, a hard disk), an optical disc (including a CD, a DVD, a Blu-ray disc), a magneto-optical disk, a magnetic tape, and a solid state memory (including flash memory, DRAM, SRAM, a solid state drive)) can be employed as a computer-readable medium for the computer-executable instructions. The computer-executable instructions may be written to a computer-readable medium provided on a function-extension board inserted into the device or on a function-extension unit connected to the device, and a CPU provided on the function-extension board or unit may implement the operations of the above-described embodiments.

This disclosure has provided a detailed description with respect to particular explanatory embodiments. However, the scope of the appended claims is not limited to the above-described embodiments and includes various modifications and equivalent arrangements.

What is claimed is:

1. A method of sharing revenue in an Internet printing system, the method comprising:
receiving a requested web page at a browser operating on a user computer, wherein the browser is associated with a user account operated by a browser provider;
generating a browser window that displays the requested web page;
generating a browser interface that presents an option to print the requested web page with additional unrequested advertisement data included therein;
receiving a selection of the option to print the requested web page and the additional unrequested advertisement data;
after receiving the selection of the option to print the requested web page and the additional unrequested advertisement data, receiving the additional unrequested advertisement data from an advertisement sponsor at the browser;
generating print data that includes the requested web page and the additional unrequested advertisement data from the advertisement sponsor;
sending the print data to the printer driver;
receiving a confirmation message from the printer driver indicating that the printing of the additional unrequested advertisement data was successful;
sending a charge to an account of the advertisement sponsor for the printing of the additional unrequested advertisement data; and
sending a credit to the user account for the selection of the option to print the additional unrequested advertisement data.

2. The method of claim 1, wherein the browser provider selects the unrequested advertisement data.

3. The method of claim 1, wherein the browser determines a layout of the unrequested advertisement data on the page.

4. The method of claim 1, wherein the browser and driver communicate via a proprietary API.

5. The method of claim 1, further comprising determining if the printer driver is compatible with a browser revenue sharing feature, wherein the browser displays the selection window if the printer driver is compatible and does not display the selection window if the printer driver is not compatible.

6. The method of claim 1, further comprising presenting a login window in response to receiving the selection of the option to print the requested web page and the additional unrequested advertisement data, wherein the login window receives credentials to log in to the user account.

7. The method of claim 1, further comprising notifying a computer associated with the browser provider that the printing of the additional unrequested advertisement data was successful, and wherein the browser provider sends a charge to the advertisement sponsor and credits the user account.

8. A method of sharing revenue in an Internet printing system, the method comprising:
receiving a request to print content displayed on a browser window generated by a browser, wherein the request is associated with a user account;
selecting additional advertisement data generated by an advertisement sponsor;
generating print data that includes the content and the additional advertisement data;
sending the print data to a printer driver;
receiving a confirmation from the printer driver indicating that the printing of the additional advertisement data was successful;
sending a charge to the advertisement sponsor; and
sending a credit to the user account.

9. The method of claim 8, wherein the request includes browser information, and wherein the additional unrequested advertisement data is selected based at least in part on the browser information.

10. The method of claim 8, further comprising confirming that the printer driver supports a print confirmation capability.

11. The method of claim 8, wherein the print data is generated by a different computer than the computer that operates the browser.

12. The method of claim 8, wherein the print data is generated by the browser.

13. One or more computer-readable media storing instructions that, when executed by one or more computers, cause the computers to perform operations comprising:
receiving content at a browser;
receiving advertisement data from one or more advertisement sponsor computers;
generating a browser windows that displays the content;
receiving a request to print the content;
receiving an indicator of a user account associated with the request to print the content;
selecting at least some of the additional advertisement data for printing;
generating print data that includes the content and the selected additional advertisement data;
sending the print data to a printer driver;
receiving a confirmation from the printer driver indicating that the printing of print data;
sending a charge to the advertisement sponsor; and
sending a credit to the user account.

14. The one or more computer-readable media of claim 13, wherein the browser operates on a first computer, and wherein a second computer selects at least some of the additional advertisement data for printing.

15. The one or more computer-readable media of claim 14, wherein the browser operating on the first computer generates the print data.

16. The one or more computer-readable media of claim 14, wherein the second computer generates the print data.

17. The one or more computer-readable media of claim 14, wherein the second computer receives the advertisement data from the advertisement sponsor computers.
